(19) United States
(12) Patent Application Publication
(10) Pub. No.: US 2006/0083324 A1
(43) Pub. Date: Apr. 20, 2006

(54) Method and apparatus for detecting transmission errors for digital subscriber lines

(76) Inventors: Philip DesJardins, Nevada City, CA (US); Hossein Sedarat, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/185,648

(22) Filed: Jul. 20, 2005

Related U.S. Application Data
(60) Provisional application No. 60/619,358, filed on Oct. 15, 2004.
(60) Provisional application No. 60/619,359, filed on Oct. 15, 2004.
(60) Provisional application No. 60/619,300, filed on Oct. 15, 2004.

(51) Int. Cl. H04K 1/10

(52) U.S. Cl. 375/260

(57) ABSTRACT

A multi-carrier communication system receives a plurality of data frames comprised of a plurality of bit groups in a data stream of the multi-carrier communication system, wherein up to R bit groups are identified as corrupted by analyzing corresponding tone values, and corrects the up to R bit groups associated with one or more corrupt frames of the plurality of data frames.

### RELATED APPLICATIONS

This application claims the benefit of U.S. Provisional Application No. 60/619,358, filed Oct. 15, 2004, and U.S. Provisional Application No. 60/619,359, filed Oct. 15, 2004, and U.S. Provisional Application No. 60/619,300, filed Oct. 15, 2004, which are incorporated herein by reference in their entirety.

### TECHNICAL FIELD

The present invention relates generally to a multi-carrier communication system and, more specifically, to correcting data transmission errors caused by impulse noise.

### BACKGROUND

A multi-carrier communication system, such as a Discrete Multi-Tone (DMT) system in the various types of Digital Subscriber Line-xDSL (e.g., ADSL and VDSL) systems, carries information from a transmitter to a receiver over a number of tones. The tones are also commonly referred to as sub-carriers or sub-channels. Each tone acts as a separate communication channel to carry information between a local transmitter-receiver device and a remote transmitter-receiver device.

DMT communication systems use a modulation method in which the available bandwidth of a communication loop, such as twisted-pair copper media, is divided into numerous sub-channels. The term communication loop is understood to refer generally to a physical transmission medium, including copper, optical fiber, and so forth, as well as other transmission mediums, including radio frequency (RF) and other physical or non-physical communication signal paths.

There are various sources of interference and noise in a multi-carrier communication system. Interference and noise may corrupt the data-bearing signal on each tone as the signal travels through the communication loop and is decoded at the receiver. The received data-bearing signal may be decoded erroneously by the receiver because of this signal corruption.

In order to account for potential interference on the transmission line and to guarantee a reliable communication between the transmitter and receiver, each tone can carry a limited number of data bits per unit time. This number is related to a bit error rate (BER) for a given tone. The number of data bits or the amount of information that a tone carries may vary from tone to tone and depends on the relative power of the data-bearing signal compared to the power of the corrupting signal on that particular tone. The number of bits that a specific tone may carry decreases as the relative strength of the corrupting signal increases.

Examining DMT modulation helps understand how noise affects a DMT communication system. For example, when modulating on a DMT communication system, data samples on each tone are represented as one of a set of finite number of points in a two dimensional (2D) Quadrature Amplitude Modulation (QAM) constellation. FIG. 1A is a scatter plot of a QAM constellation illustrating received signal samples. The transmit data in a multi-carrier system is usually represented by a point from a constellation of a finite set of possible data points regularly distributed over a two dimensional grid. The set of received signal samples in this example were chosen from a set of 16 data points in a QAM constellation 100. Thus, the grid of QAM constellation 100 represents sixteen different possible data values that could be carried by that tone.

The transmitted data point is located at the center of each cell bounded by the decision boundaries 102. For example, a first cell 104 with an expected transmitted data point having coordinates of (+0.5, +0.5). If there is no noise or other sources of error, the received data point will coincide with the transmit point located at the center of each cell bounded by the decision boundaries 102.

The dashed lines indicate decision boundaries 102 for the 4×4 QAM constellation grid 100 of potential data values. The dots represent the received signal points which due to noise or interference will differ from the transmitted point represented by the center of each cell. These error differences are known as error samples and may be processed to determine the power of the noise that perturbs the actual received value from the expected value for each point.

The center coordinates of a particular cell for example, (+0.5, +0.5) for sample cell 104, represent the expected amplitude and phase of the transmitted data for that data point. A transmitted data point within the boundaries of a given cell allows that transmitted data point to be assigned a data value associated with that cell. However, because of noise error present in the system, the received data point or actual signal may be detected some distance from the expected ideal reference signal or transmitted point. The distance from the expected transmitted point, for example the center of sample cell 104 at coordinates (+0.5, +0.5), to the actual coordinates of the received error samples in that cell represent the detected transmission error.

FIG. 1B further illustrates a transmission error by showing an ideal reference signal 110 corresponding to ideal sample 111 versus an actual signal 112 corresponding to error sample 113 within a QAM cell, such as sample cell 104.

FIG. 2A is a scatter plot 200 of a QAM constellation, which illustrates an aggregate of all received signal samples 202 in a 2D plane. The error samples 202 may be obtained from acquiring a training signal to characterize and measure noise relative to an ideal transmission sample. The coordinates of the ideal transmission sample for any cell are at the center point of the scatter plot 200 (i.e., 0, 0). The distance of a received signal sample from the center point or ideal value is a quantity representing the magnitude of the error for that received signal sample. When the source of the noise error is an additive white Gaussian noise (AWGN), then the plotted values of error magnitude 202 in each I or Q direction relative to the center point have a Gaussian distribution, as illustrated by the plot shown in FIG. 2B.

FIG. 2B is a Gaussian distribution plot 252 illustrating error samples from background noise shown in scatter plot 200 of FIG. 2A. The Gaussian distribution of the error samples 250 from background noise has a peak probability density 252 of 0.4 (Y-axis), which is closest to the expected transmitted data point corresponding to samples found at coordinates (0, 0) of scatter plot 200. For simplicity, Gaussian distribution plot 252 shows an exemplary Probability Density Function value of 0.4 for the peak probability density 252. However, it can be appreciated by those skilled in the art that this value depends on such factors as noise source type, noise power, etc.

The probability of the error samples decreases as the absolute value of the magnitude of the error increases, thus creating a bell shaped curve. The Gaussian distribution of the error samples 250 from background noise will have a given probability distribution. The Gaussian distribution of the error samples 250 will also have a standard deviation 254 derived from the Gaussian distribution of background noise approximately equal to the square root of the power level of the noise. The standard deviation 254, in addition to other statistical parameters known in the art, may be calculated and used, or stored and later used by the DMT system.

It is often assumed that the corrupting signal is an additive, white Gaussian noise (AWGN) source. With this assumption, the number of data bits that each tone can carry relates directly to the signal-to-noise power ratio (SNR). The relative power of noise and data-bearing signal may be measured during a training period established between a first transmitter-receiver device and a second transmitter-receiver device in the discrete multi-tone system. Using these measurements, a bit-loading algorithm may determine how much information bit can be loaded on each tone reliably.

However, bit-loading algorithms are typically designed based on the assumption that noise is additive, white and Gaussian. This assumption and the corresponding solution may not be true in many practical cases where various sources of interference do not have a white, Gaussian distribution. Impulse noise is one of those noise sources.

FIG. 3A is a noise graph 300 illustrating impulsive noise across several transmitted frames composed of multiple tones. Gaussian noise range 302 illustrates the boundaries of the highly probable Gaussian noise values. However, as illustrated by impulse peak 304 and 306, a frame or several frames may experience impulsive noise clearly outside the Gaussian noise range 302 and may cause frequent false decoding decisions at the receiver. For simplicity, noise graph 300 shows a filtered and smooth varying noise source, however, it can be appreciated by those skilled in the art that plots pertaining to a noise source—Gaussian and/or impulsive—may vary very rapidly in time producing a more jagged plot.

FIG. 3B is a scatter plot 330 similar to the scatter plot 200 discussed in FIG. 2A. However, scatter plot 330 includes error samples, such as error sample 332, notably outside an area defined by the high density of error samples representing AWGN about center point (0, 0). Error sample 332 may represent an impulsive noise signal as illustrated by a data point within impulse peak 304 or 306, and may be called an outlier since it has a value associated with its coordinates outside the expected AWGN range.

FIG. 3C is a noise distribution curve 350, which is similar to the Gaussian distribution plot 252 except that in addition to the Gaussian distribution curve 352, the plot also illustrates outlier distribution curves 354 and 356. The outlier curves are a result of impulsive noise contribution to the reference signal. As illustrated, the impulsive noise has a probability of large-magnitude error relative to the usual Gaussian distribution caused by AWGN.

A bit loading algorithm, based on the assumption of AWGN sources, underestimates the effects of impulse noise. The result of impulse noise on a system designed with an AWGN assumption is an excessive rate of error. Current error detection schemes employed in digital subscriber line data transmission standards may identify an impulse noise error but do not localize errors to within a single DSL frame (the smallest symbol size). This interferes with being able to precisely analyze the location and periodicity of error events. The DSL standard aggregates all bytes to be delivered into a group called a frame. For DSL, each frame is sent out at a rate of approximately 4000 per second. A frame transports N bytes during this time. A checksum is calculated and sent as the first byte (error check byte) of every 68^{th} data frame comprising a superframe (for ADSL); this means that the receiver cannot locate a corrupted frame with any precision finer than the superframe. The error check bytes represent the checksum or other error product of an error detection calculation known in the art, such as CRC (Cyclic Redundancy Code/Checksum). A checksum is a computed value which depends on the contents of a block of data and is transmitted along with the data in order to detect corruption of the data upon reception. The checksum may be 8 bits (modulo 256 sum), 16, 32, or some other size.

Using a CRC, T error check bytes appended to a frame within a byte stream are based on determining the remainder of a polynomial division of the bits in the byte stream with a generating polynomial of 8*T bits. The value of T, that is the number of bytes to append to the incoming stream, can vary and generally the error detecting capacity of the CRC increases as T increases with the offsetting disadvantage that the data payload (N-T) decreases, where the frame size is fixed at N.

The transmitter receives N-T bytes and appends T error check bytes (T≦1) to form a byte group composed of N-bytes bytes that are tone-mapped and modulated for transmission. The values of the T error check bytes and the methods for generating them are chosen such that reception errors can be detected by the receiver. The receiver detects the reception errors by receiving the signal and generating the N bytes for the frames, performs the complementary operation on the N received bytes. In one embodiment of the present invention, a binary polynomial division of the received bytes is performed; if no reception errors occurred then the remainder would result in a known value, often zero, otherwise the frame is declared to be in error. If in error, the receiver sends that determination to other elements of the receiver for possible corrective action. The remaining N-T bytes are passed along for subsequent processing in the receive chain.

In any event, such imprecision prohibits the ability to analyze error rates beyond the superframe, detect repetitive or spurious impulse noise, or to try to take corrective action on a known corrupted frame. The use of the current checksum is merely for line quality monitoring.

### BRIEF DESCRIPTION OF THE DRAWINGS

The present invention is illustrated by way of example, and not by way of limitation, in the figures of the accompanying drawings in which:

FIG. 1A illustrates a QAM constellation of detected samples.

FIG. 1B illustrates an ideal reference signal versus an actual received signal corresponding to a transmission error.

FIG. 2A illustrates scatter plot of a cell in a QAM constellation.

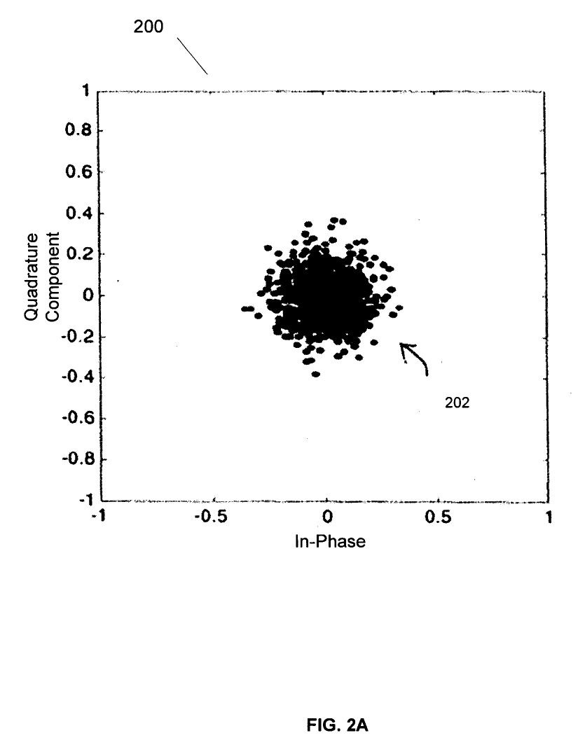

FIG. 2B illustrates a Gaussian probability density distribution plot of error samples corresponding to background noise.

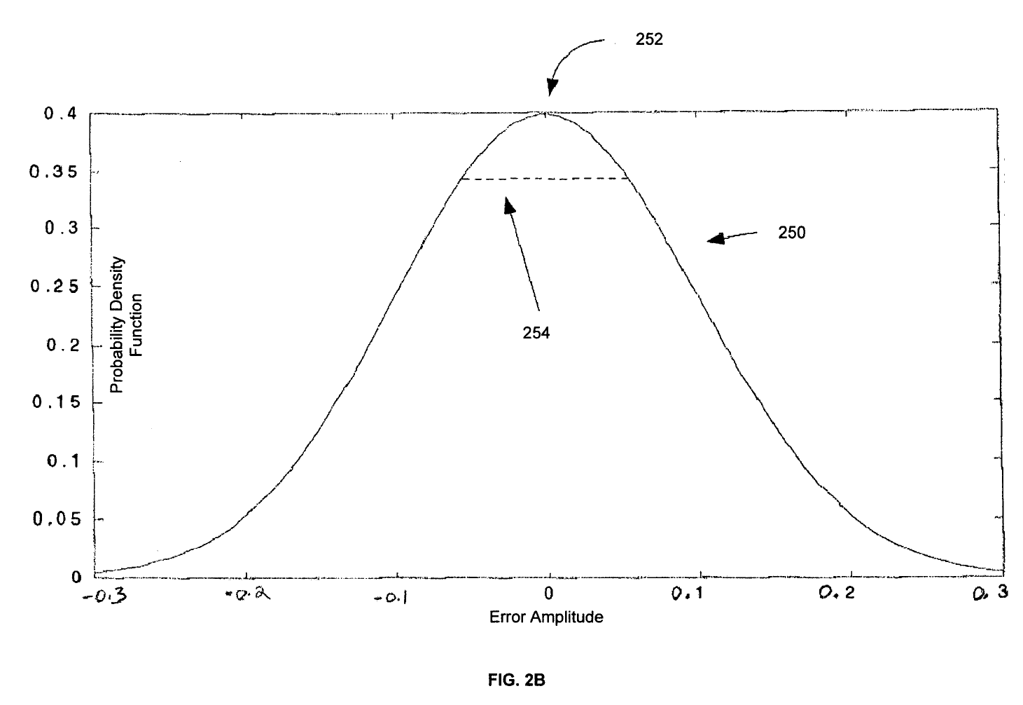

FIG. 3A is a noise graph illustrating Gaussian and impulsive noise across several transmitted frames.

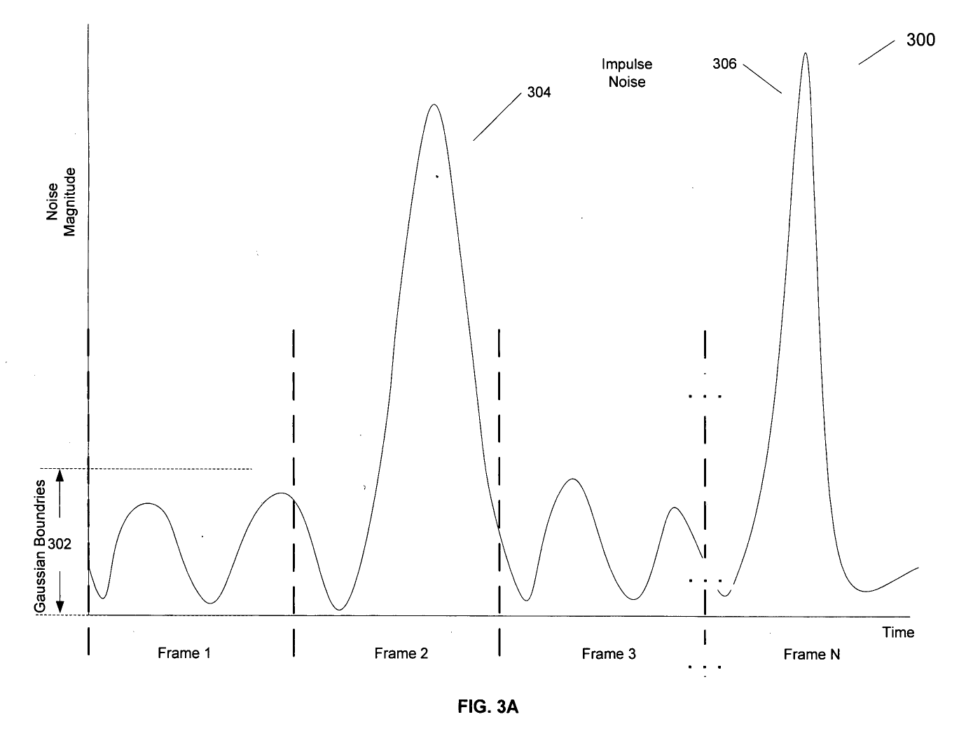

FIG. 3B is a scatter plot of error samples illustrating an impulse noise contribution.

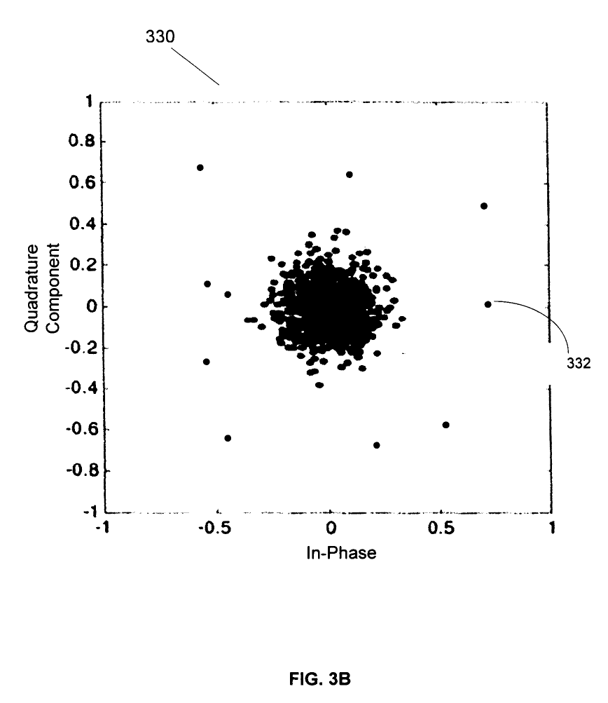

FIG. 3C is a noise probability density distribution curve illustrating both a Gaussian noise source and an impulse noise source.

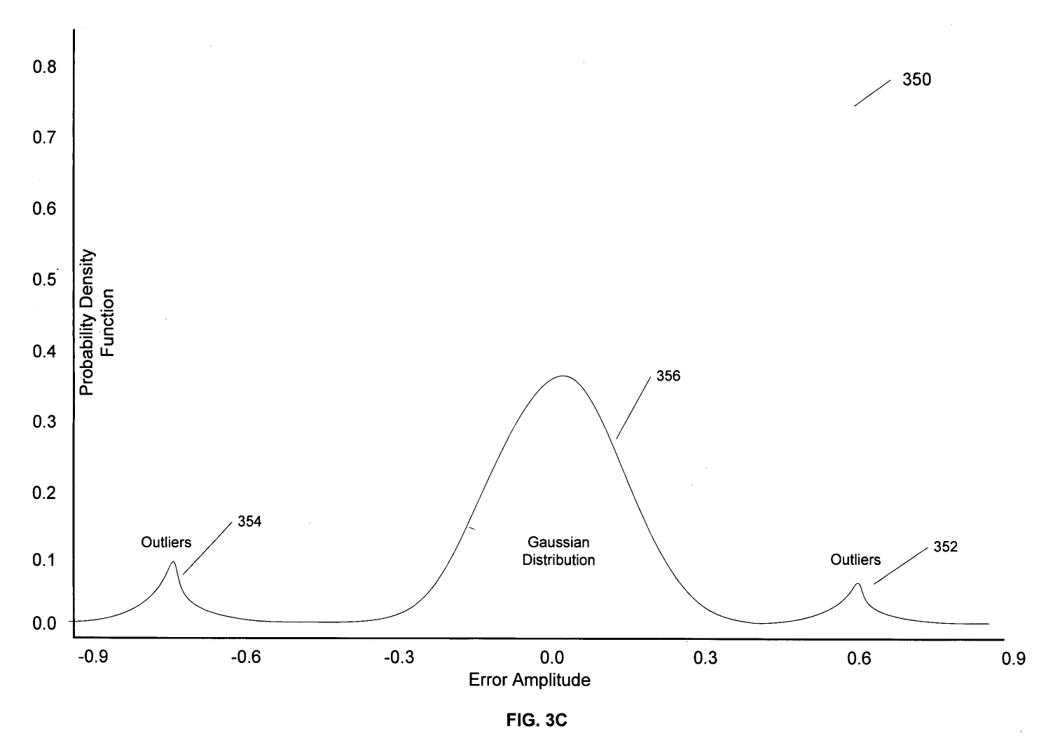

FIG. 4 is a block diagram illustrating an embodiment of a discrete multi-tone system for detecting and correcting transmission errors associated with impulsive noise.

FIG. 5A is a block diagram illustrating an embodiment of a receiver in a multi-carrier communication system configured to detect and correct corrupted bit groups within a corrupted frame.

FIG. 5B is a block diagram illustrating an alternate embodiment of a receiver in a multi-carrier communication system configured to detect and correct corrupted bit groups within a corrupted frame.

FIG. 5C illustrates a plurality of 3-byte arrays (frames) and corresponding 3-bit arrays (flag values) before and after de-interleaving.

FIG. 6 illustrates an embodiment of a receiver in a multi-carrier communication system configured to utilize error check bytes.

FIG. 7 illustrates an embodiment of a corrupted frame detector configured to use noise power analysis to determine which of a plurality of frames are corrupted frames.

FIG. 8 illustrates an alternative embodiment of a corrupted frame detector configured to utilize an error power outlier counter to identify corrupted frames.

FIG. 9 illustrates a constellation point and a threshold outlier value.

FIG. 10 is a flow chart illustrating an embodiment for receiving, detecting and correcting corrupt bit groups in a multi-carrier communication system.

FIG. 11 is a flow chart illustrating other embodiments of the present invention for detecting and correcting corrupt bit groups using noise power values of received tones to identify corrupt frames in a multi-carrier communication system.

FIG. 12 is a flow chart illustrating an embodiment for detecting and correcting corrupt bit groups in a data frame using error check bytes to identify corrupt frames in a multi-carrier communication system.

### DETAILED DESCRIPTION

In the following detailed description, numerous specific details are set forth in order to provide a thorough understanding of the invention. However, it will be understood by those skilled in the art that certain embodiments of the present invention may be practiced without these specific details. In other instances, well-known methods, procedures, components, and circuits have not been described in detail so as not to obscure the presented embodiments of the invention. The following detailed description includes several modules, which will be described below. These modules may be implemented by hardware components, such as logic, or may be embodied in machine-executable instructions, which may be used to cause a general-purpose or special-purpose processor programmed with the instructions to perform the operations described herein. Alternatively, the operations may be performed by a combination of hardware and software. The following detailed description refers to bytes and frames of data. It can be appreciated by those skilled in the art that a byte is bit group composed of eight bits and a frame is merely a set of bit groups. For simplicity, the specification will refer to a byte, but it can be appreciated the methods and apparatuses disclosed herein may operate on a bit group composed of one or more bits.

Apparati, systems, and methods are described for a multi-carrier communication system that detects and corrects impulse noise present at a receiver of the communication system. A transmitter-receiver device may detect impulse noise present in a multiple tone system, and specifically in a received frame composed of a bit group, and mark that frame for erasure decoding if impulse noise is detected.

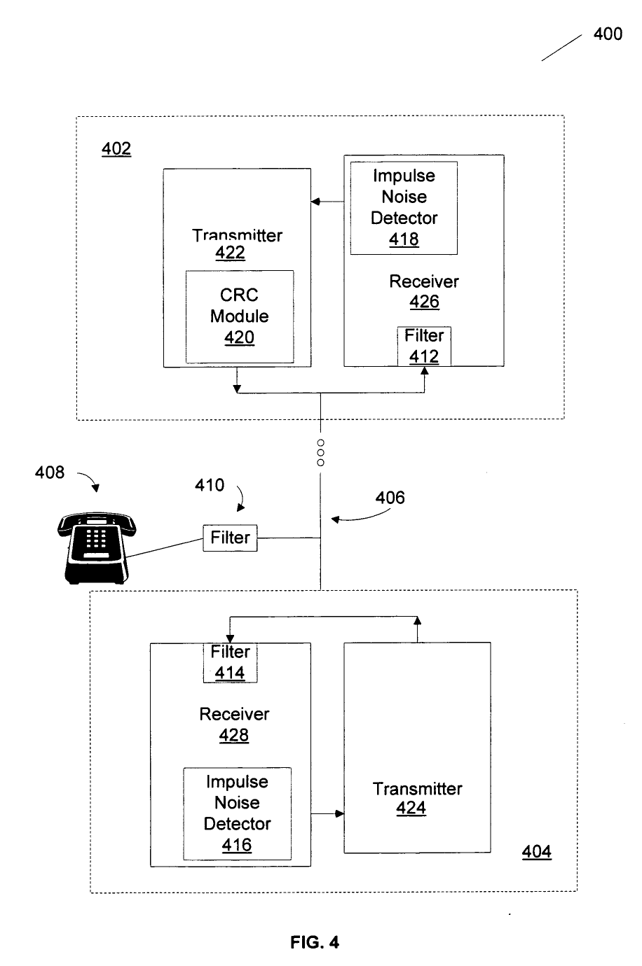

FIG. 4 is a block diagram illustrating an embodiment of a discrete multiple tone system 400 for detecting and correcting reception errors associated with impulsive noise for very high speed digital subscriber lines. The discrete multiple tone system 400, such as a Digital Subscriber Line (xDSL) based network, may have two or more transmitter-receiver devices 402, 404, such as a DSL modem in a set top box. In one embodiment, the set top box may be a stand-alone DSL modem. In one embodiment, for example, the set top box employs a DSL mode along with other media components to combine television (Internet Protocol TV or Satellite) with broadband content from the Internet to bring the airwaves and the Internet to an end user's TV set. The multiple carrier communication channel may communicate a signal to a residential home. The home may have a home network, such as an Ethernet. The home network may either use the multiple carrier communication signal, directly, or convert the data from the multiple carrier communication signal. The set top box may also include an integrated Satellite and Digital Television Receiver, High-Definition Digital Video Recorder, Digital Media Server and other components.

The first transmitter-receiver device 402, such as a Discrete Multi-Tone transceiver, transmits and receives communication signals from the second transmitter-receiver device 404 over a transmission medium 406, such as a telephone line. Other devices such as telephones 408 may also connect to this transmission medium 406. An isolating filter 410 generally exists between the telephone and the transmission medium 406. A training period occurs when initially establishing communications between the first transmitter-receiver device 402 and a second transmitter-receiver device 404 to measure AWGN (Additive White Gaussian Noise).

The discrete multiple tone system 400 may include a central office, and an end user. The central office may contain the first transmitter-receiver device 402 that communicates with the second transmitter-receiver device 404 at an end user's location.

xDSL transmitters 422, 424 (e.g., ADSL and VDSL) take data in groups of N bytes—where N is determined by the transmission bit rate and varies according to standard and line conditions—and maps the bits in these N bytes to a set of amplitude and phase values for a plurality of tone generators that transmit for a short period of time. The implementation of the plurality of tone generators is typically performed using the Inverse Fast Fourier Transform (IFFT) method that is well known by those of ordinary skill in the art. After this frame time, the transmitter 422, 424 receives a new set of N bytes for further transmission.

Each transmitter 422, 424 portion of the transmitter-receiver device 402, 404 may transmit data over a number of mutually independent sub-channels (i.e., tones). Each sub-channel carries only a certain portion of data through QAM (Quadrature Amplitude Modulation) of the sub-carrier. The number of information bits loaded on each tone and the size of corresponding QAM constellation may potentially vary from one tone to another and depend generally on the relative power of signal and noise at the receiver 426, 428. When the characteristics of signal and noise are known for all tones, a bit-loading algorithm can determine the optimal distribution of data bits and signal power amongst sub-channels. Thus, the transmitter 422, 424 portion of the transmitter-receiver device 402, 404 modulates each sub-carrier with a data point in a QAM constellation.

Each transmitter-receiver device also includes a receiver 426, 428 portion that contains a noise detector 416, 418. Each noise detector 416, 418 may contain software and/or logic programmed to detect for the presence of impulse noise present in the system. In one embodiment, each noise detector 416, 418 may detect impulse noise by comparing error check bytes transmitted with a frame of data composed of a plurality of bit groups to error check bytes generated at the receiver for the same plurality of bit groups. If the generated error check bytes do not match, each noise detector 416, 418 may create a plurality of flag values to flag the corresponding plurality of bit groups for erasure decoding and correction.

In another embodiment, each noise detector 416, 418 may detect an error difference between the amplitude of each transmitted data point in the QAM constellation and expected amplitude for each data point in the QAM constellation. A plurality of data points comprises a bit group and a plurality of bit groups comprises a data frame. Each noise detector 416, 418 may generate an error value corresponding to the difference between the actual detected constellation point and the expected transmitted constellation point. The error difference or noise amplitude value for each transmitted data point may also be referred to as an error sample. Each noise detector 416, 418 may measure an average error amplitude value of all of the detected error samples to determine a standard deviation of a Gaussian distribution of background noise and compare an amount of peak error samples to a threshold value to determine if impulse noise is present on a particular tone. The threshold value may be based upon a standard deviation and/or average or other statistical value derived from the Gaussian distribution of background noise. If impulse noise is present within the plurality of received tones, each noise detector 416, 418 may create a plurality of flag values to flag the corresponding plurality of bit groups for erasure decoding and correction.

In yet another embodiment, each noise detector 416, 418 may sum the square of the noise amplitude values to create a total noise power present on the transmission medium. Each noise detector 416, 418 may then compare the total noise power to a threshold value to determine if impulse noise is present on a particular tone. If impulse noise is present within the plurality of received tones, each noise detector 416, 418 may create a plurality of flag values to flag the corresponding plurality of bit groups for erasure decoding and correction.

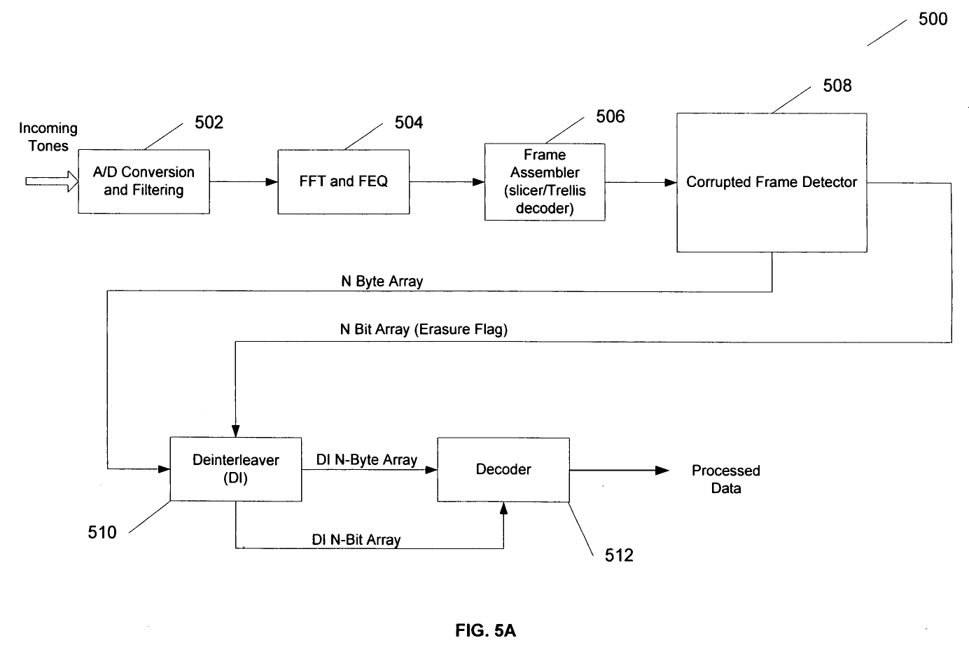

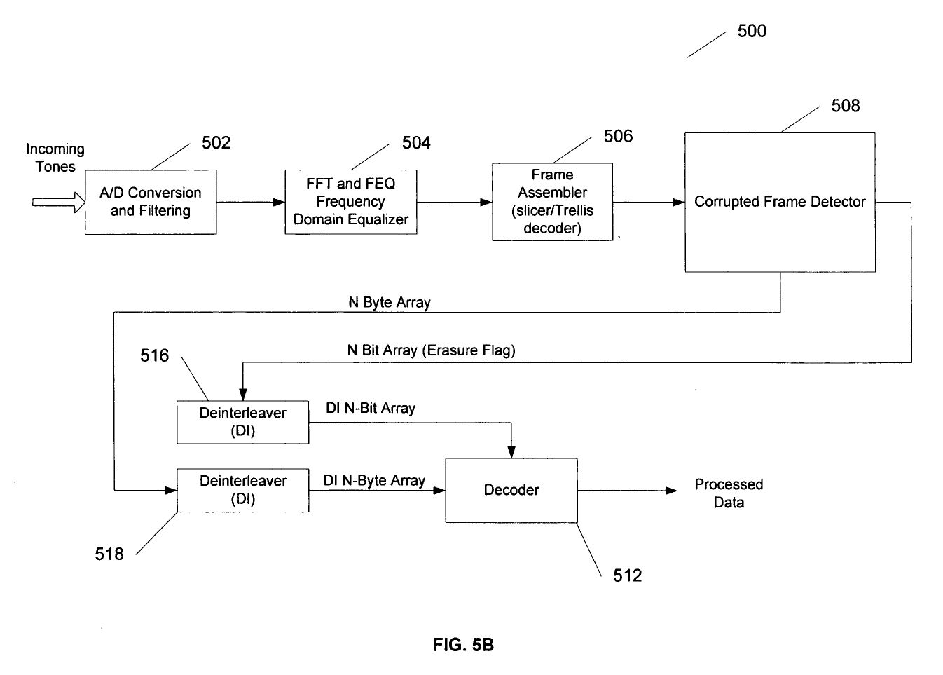

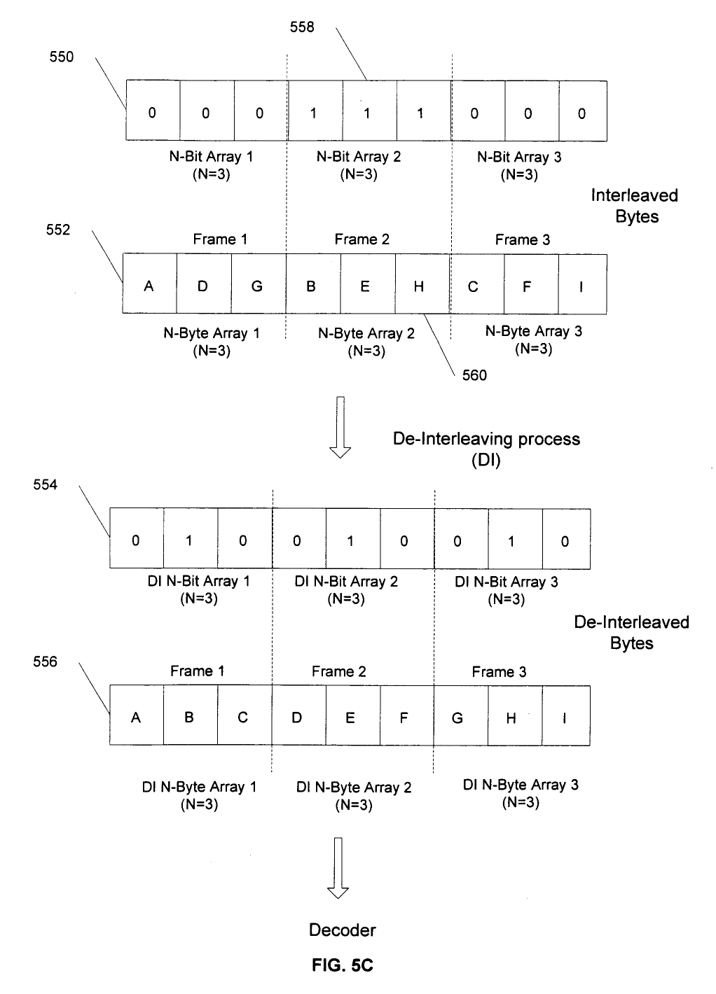

In order to decode and correct bit groups of a corrupted frame, an encoding algorithm may be used that supports erasure decoding. One such algorithm, for example, is Reed-Solomon (RS) encoding/decoding. RS codes are block-based error correcting codes with a wide range of applications in digital communications and storage. They are used to correct errors in many systems such as digital storage devices, wireless/mobile communications, and digital video broadcasting. The RS decoder processes blocks generated by an RS encoder, attempting to correct errors and recover information symbols corresponding to bit groups. The number and type of errors that can be corrected depend on the characteristics of the code. RS codes are Bose-Chaudhuri-Hocquenghem (BCH) codes, which in turn are linear block codes and are well known in the art. Most importantly, the decoder 512 (See FIG. 5A) is able to handle erasures (erasure decoding), which are symbols that are known with high probability to contain errors. Therefore, the precise locations of the symbols or bit groups in a corrupted frame must be known. If these locations are known, an RS code that uses R redundant bytes per codeword can detect and correct up to the R bytes. Whereas, without erasures, the decoder may only correct up to R/2 bytes.

FIG. 5A is a block diagram illustrating an embodiment of a receiver 500 in a multi-carrier communication system configured to detect and correct corrupted bit groups within a corrupted frame. In the receiver 500 (i.e., receiver 426, 428 portion of the discrete multiple tone system 400) incoming tones are first received at an analog digital conversion unit 502. The resulting digital signal is processed by the FFT (Fast Fourier Transform) and the FEQ (frequency domain analyzer) 504. Once processed the digital signal is passed on to the frame assembler 506. The frame assembler 506 is a decoder that assigns bits according to the received signal. In varying embodiments, frame assembler 506 may use a slicing algorithm or trellis decoding if the corresponding transmitter used trellis encoding. A slicing algorithm is a simple nearest-point decision criterion, also known in the art as a slicer, while Trellis encoding/decoding is a convolutional code and is a form of forward error correction (FEC). It is well known in the art and used in the xDSL standards.

Once the data bits have been formed into bit groups and further grouped into frames, the frames are passed on to a corrupted frame detector 508. For simplicity, hereinafter, bit groups will be referred to as bytes but embodiments of the present invention are not so limited. Further, it can be appreciated that in various other embodiments, a flag value may be a single bit value or another value associated with two or more bits.

In one embodiment the corrupted frame detector 508 analyzes each byte up to N-bytes where N-bytes comprises a data frame. The output of the corrupted frame detector results in an N-byte array and N-bit array. Each bit of the N-bit array represents a flag value for each corresponding byte of the N-byte array. The flag values of the N-bit array are determined by the corrupted frame detector 508 and correspond to whether the bytes of the frame have been flagged for erasure decoding. For example, a corrupt frame may be marked for erasure decoding by setting all corresponding values of the N-bit array to ‘1.’ If the frame is not corrupt, the values of the N-bit array may be set to the value ‘0.’ In another embodiment, the corrupted frame detector 506 may alternatively output only a single bit indicating a corrupt frame, and retain that value to flag all N bytes of the frame.

Both corrupt and non-corrupt frames composed of their corresponding N-byte arrays and the N-bit arrays are passed to a de-interleaver 510 where they are de-interleaved as illustrated in FIG. 5C. De-interleaving is a process well known in the art whereby bytes of data that were previously re-ordered or interleaved are assembled back into their original order or de-interleaved. If the flag values of the N-bit array indicate the bytes of the frame have been marked corrupt, then the de-interleaver 510 operates to de-interleave a plurality of byte arrays (frames) and their corresponding N-bit arrays (flag values) such that the error bytes and their respective error bits are distributed over the plurality of other non-corrupt N-byte and corresponding N-bit arrays. The de-interleaved arrays are then passed to decoder 512, wherein erasure decoding corrects the corrupted bytes of data identified by the de-interleaved flag values.

FIG. 5C illustrates a plurality of 3-byte arrays (frames) and corresponding 3-bit arrays (flag values) before and after de-interleaving. N is set to 3 and is merely for illustrative purposes, it can be appreciated by those skilled in the art that N may be optimized for de-interleaving and erasure decoding.

Interleaved frame group 552 illustrates three interleaved frames and interleaved bit group 550 illustrates their corresponding bits/flags. Byte array 560, corresponding to frame 2, has been flagged corrupt as illustrated by bit array 558 having flag values set to ‘1.’ Frame 1 and frame 3 have not been flagged as corrupt. Upon de-interleaving the three frames and their corresponding bit arrays, the original byte order is restored as shown by de-interleaved frame group 556. However, as shown by de-interleaved bit group 554, the erasure flags have also been reordered and the bytes flagged for correction (i.e., ‘1’) are distributed throughout each bit array corresponding to the frames (byte arrays). Such a distribution increases the decoder's ability to correct the identified corrupted bytes, as is commonly known in the art.

FIG. 5B illustrates a block diagram of an alternate embodiment of the receiver 500 in a multi-carrier communication system configured to detect and correct corrupted bit groups within a corrupted frame. Receiver 500 of FIG. 5B has substantially identical components to that of receiver 500 of FIG. 5A, except for de-interleaver 510. Here, a dual-field de-interleaver composed of two separate de-interleavers 516 and 518 receive the N-bit array of erasure flags and the N-byte array, respectively. The de-interleaved N-bit array and de-interleaved N-byte array are passed to the decoder 512 for erasure decoding as previously discussed with respect to FIG. 5A.

Among various embodiments of the present invention, both de-interleavers could be implemented in hardware, both in software, or one in hardware and the other in software. If the erasure bit (flag) de-interleaver is implemented in software it may be executed optionally.

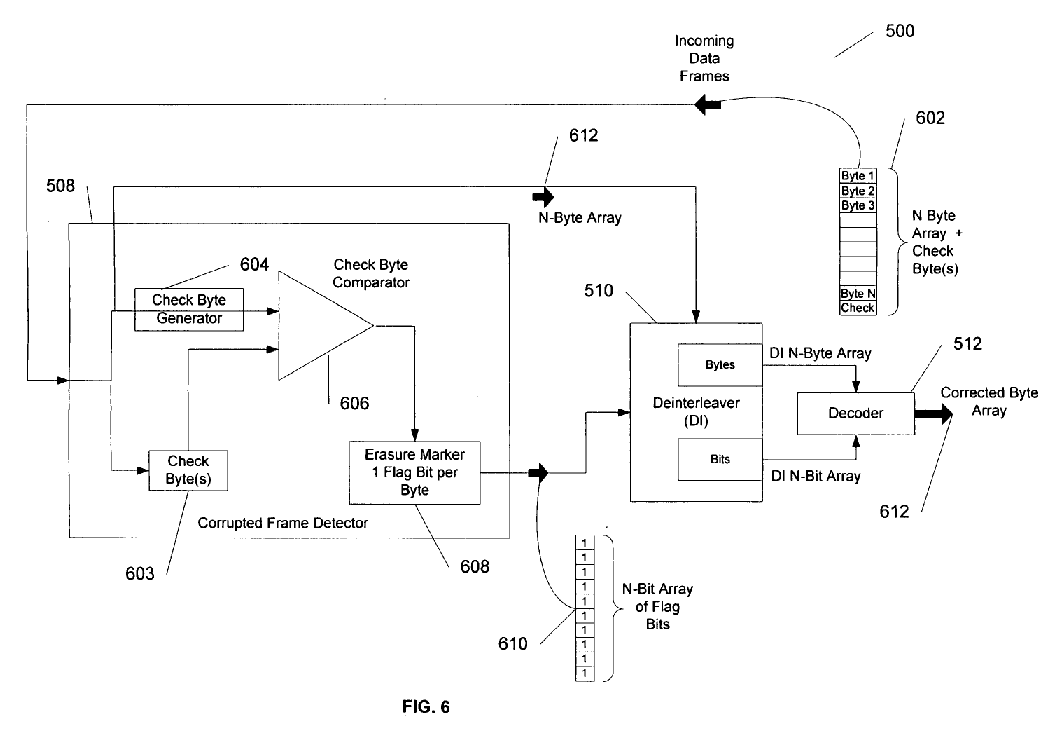

FIG. 6 illustrates an embodiment of a receiver 500 configured to use error check bytes to identify corrupt data frames for correction. Among various embodiments, the error check byte or bytes represent a checksum or other error product of an error detection calculation known in the art, such as CRC (Cyclic Redundancy Code/Checksum). A checksum is a computed value that depends on the contents of a block of data and is transmitted or stored along with the data in order to detect corruption of the data upon recall. The checksum may be 8 bits (modulo 256 sum), 16, 32, or some other size.

A CRC is more complicated than a checksum and is widely known to those of skill in the art. Using a CRC, T error check bytes appended to a frame within a byte stream are based on determining the remainder of a polynomial division of the bits in the byte stream with a generating polynomial of 8*T bits. The value of T, that is the number of bytes to append to the incoming stream, can vary and generally the error detecting capacity of the CRC increases as T increases with the offsetting disadvantage that the data payload (N-T) decreases, where the frame size is fixed at N.

For example, the transmitter (e.g., transmitter 422, 424 of FIG. 4) receives N-T bytes and appends T error check bytes (T≧1) to form byte group 602 composed of N-bytes that are tone-mapped and modulated for transmission. The values of the T error check bytes and the methods for generating them are chosen such that transmission errors can be detected by the receiver 500 (e.g., receiver 426, 428 of FIG. 4). The receiver 500 detects the transmission errors by receiving the signal and generating the N bytes for the frames, performs the complementary operation on the N received bytes. In one embodiment of the present invention, a binary polynomial division of the received bytes is performed; if no reception errors occurred then the remainder would result in a known value, often zero, otherwise the frame is declared to be in error. If in error, the receiver 500 sends that determination to other elements of the receiver (e.g., interleaver 510 and decoder 512) for possible corrective action. The remaining N-T bytes are passed along for subsequent processing in the receive chain.

In one embodiment of the present invention, an 8 bit CRC is used as follows:
crc(D)=M(D) D⁸ modulo G(D) where M(D)=m₀Dk⁻¹+ml D^{k-2}+ . . . +mₖ₋₂D+mₖ₋₁, is the message polynomial,
k=(N−1)×8, N=Total number of bytes in modulated frame
G(D)=D⁸+D⁴+D³+D²+1, is the generating polynomial,
crc(D)=c₀D7+c₁D⁶+ . . . +c₆D+c₇, is the check polynomial,
and D is the delay operator.
   That is, the CRC is the remainder when M(D) D⁸ is divided by G(D). Each byte shall be input into the crc(D) equation least significant bit first. Alternative embodiments could use CRCs with a greater number of generator polynomial bits, such as the CRC16 generator.

Returning to FIG. 6, the receiver 500 receives the byte group 602 after demodulation and processing at a corrupted frame detector 508. The corrupted frame detector 508 divides the byte group 602 into N-byte array 612 and the T error check bytes. In another embodiment, the byte group 602 may be divided into the N-byte array and the T error check bytes in the frame assembler 506. The N-byte array 612 is passed to a check byte generator 604 to generate T error check bytes corresponding to the received N-byte array. If the T error check bytes generated by the check byte generator 604 do not match the received T error check bytes at check byte comparator 606, then a transmission error has occurred.

If a transmission error has occurred, then erasure marker 608 generates an N-bit array 610 of flag values, each set to a value indicating the frame composed of the N-byte array 612 is corrupt (e.g., set to ‘1’). However, if there has not been a transmission error, then the erasure marker 608 generates an N-bit array 610 of flag values, wherein each flag value is set to indicate the frame composed of N-byte array 612 is not corrupt (e.g., set to ‘0’). In either case, a plurality of N-bit and N-byte arrays corresponding to corrupt and non-corrupt frames are de-interleaved, decoded, and corrected, as discussed above with respect to erasure decoding.

In another embodiment of the present invention, a receiver (e.g., receiver 426, 428 of FIG. 4) may analyze noise power associated with received tones to detect corrupted frames. xDSL transmits data in units referred to as frames. A frame is an aggregation of bytes whose bits are encoded across a plurality of tones. For each frame the receiver decodes the received constellation point for each tone and packs the decoded bit stream to form the received bytes. At the receiver, the average noise power compared to the constellation size is uniform across all tones. This characteristic is usually decided by the receiver when it calculates the constellation density for each tone during training.

If the sum of the noise power across all the used tones at the receiver is calculated, this sum will remain fairly constant, because of the uniformity of the average power. For any one tone the instantaneous noise power will fluctuate while maintaining a certain average power, but the instantaneous fluctuations will average out when summed across all used tones in the receiver particularly when the number of tones is large.

In the case where the received frame was corrupted by a strong impulse, several of the tones will have an elevated noise power, most likely enough to cause false decoder decisions. False decoding will reduce the apparent noise because the distance from the received point to the true point will be less than the distance from the received point to the decision point. This is due to the decoder deciding on the point that is closest to the received signal. Even with this reduction in apparent noise for some tones, the instantaneous noise power will still increase dramatically in the presence of a strong impulse.

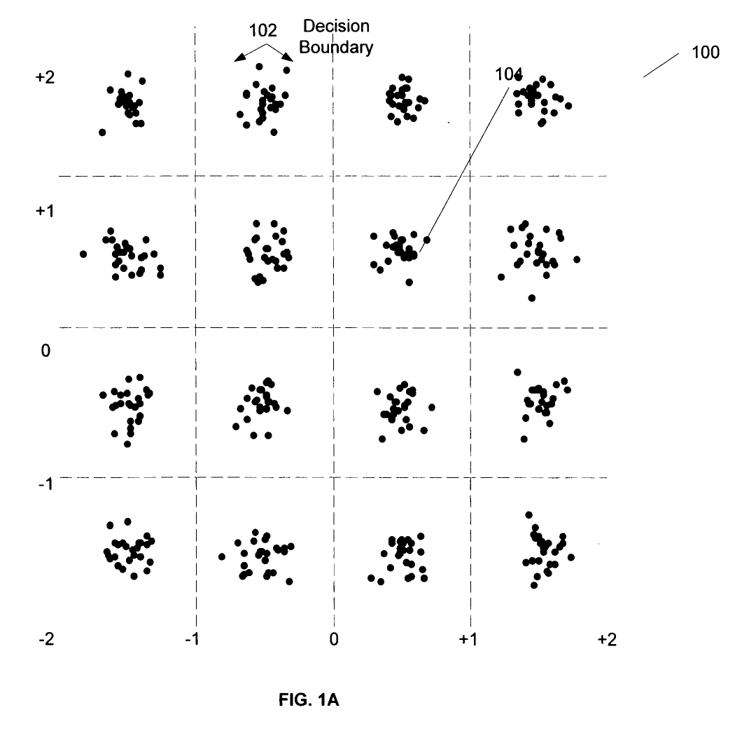

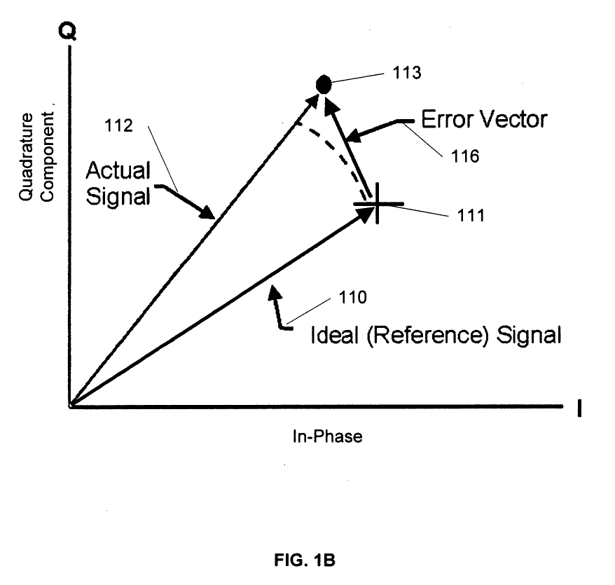

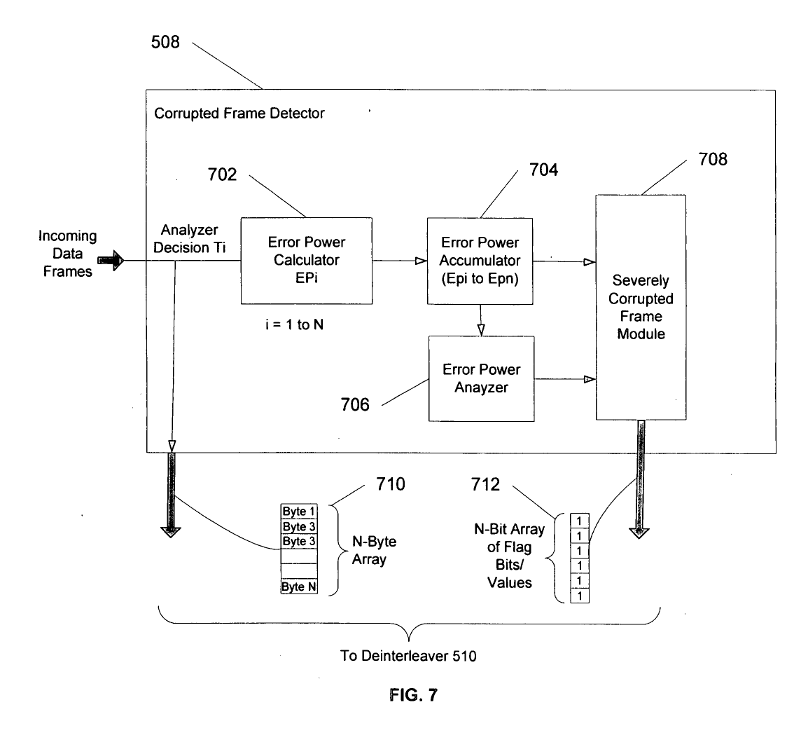

FIG. 7 illustrates an embodiment of a corrupted frame detector 508 configured to use noise power analysis to determine a corrupted frame and flag the corresponding bytes (bit groups) for correction. The corrupted frame detector 508 analyzes tones corresponding to bytes of an incoming data frame composed of an N-byte array 710. The error power calculator 702 calculates the noise power for each tone that is received by squaring the value of an error vector (e.g., See FIG. 1B) between each transmitted data point in the QAM constellation and expected amplitude for each data point in the QAM constellation. The error power accumulator 704 may then sum the noise power values to create a total noise power value for the N-byte array 710. The error power analyzer 706 may then compare the total noise power to a threshold value to determine if impulse noise has corrupted the data frame composed of the byte array 710.

If the data frame is corrupt, the severely corrupted frame module 708 generates an N-bit array 712 of flag values, each set to a value indicating the frame composed of N-byte array 710 is corrupt (e.g., set to ‘1’). However, if the data frame is not corrupt, then the corrupted frame module 708 generates an N-bit array 712 of flag values, wherein each flag value is set to indicate the frame composed of N-byte array 710 is not corrupt (e.g., set to ‘0’). In either case, a plurality of N-bit and N-byte arrays corresponding to corrupt and non-corrupt frames are de-interleaved, decoded, and corrected, as discussed above with respect to erasure decoding.

Among varying embodiments, the threshold value discussed above can be either a fixed value or calculated from the long-term average and variation of previously computed total noise power values. One method of determining the threshold would be to set it to be the total noise power average plus k times total noise power variance, where total noise power variance is based on the variation of the total noise power over a set of measurements of a set of previous frames, the total noise power average is the average of total noise power over the set of previous frames, and k is a constant that determines the sensitivity of the corrupted frame detector. As k increases the detector becomes less sensitive and may fail to detect some severely corrupted frames, as k decreases the detector becomes more sensitive and may generate false alarms.

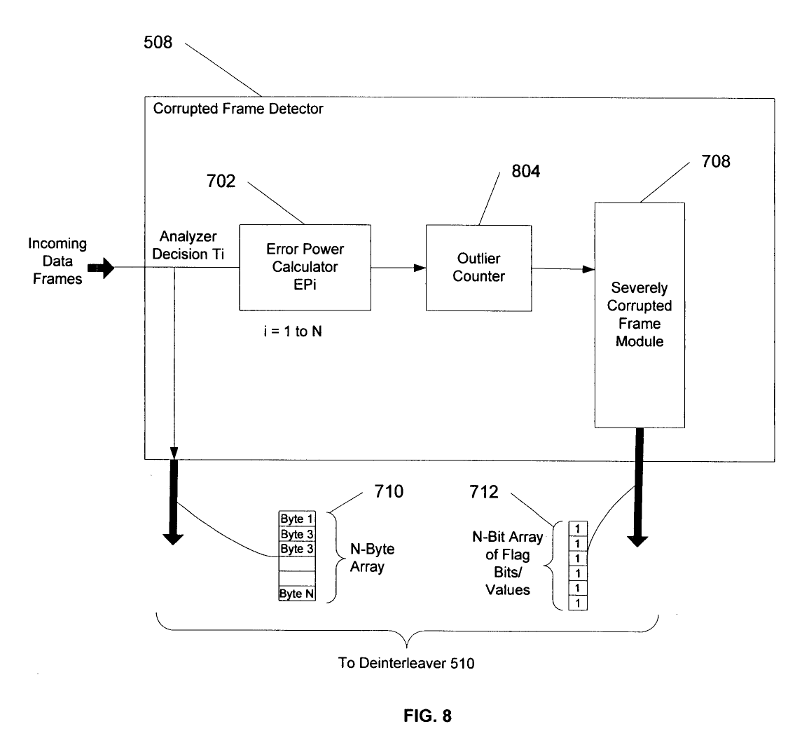

FIG. 8 illustrates an alternative embodiment of a corrupted frame detector 508 configured to use an error power outlier counter to identify corrupted frames. The corrupted frame detector 508 analyzes tones corresponding to bytes of an incoming data frame composed of an N-byte array 710. The error power calculator 702 calculates the noise power for each tone that is received by squaring the value of an error vector (e.g., See FIG. 1B) between each transmitted data point in the QAM constellation and expected amplitude for each data point in the QAM constellation.

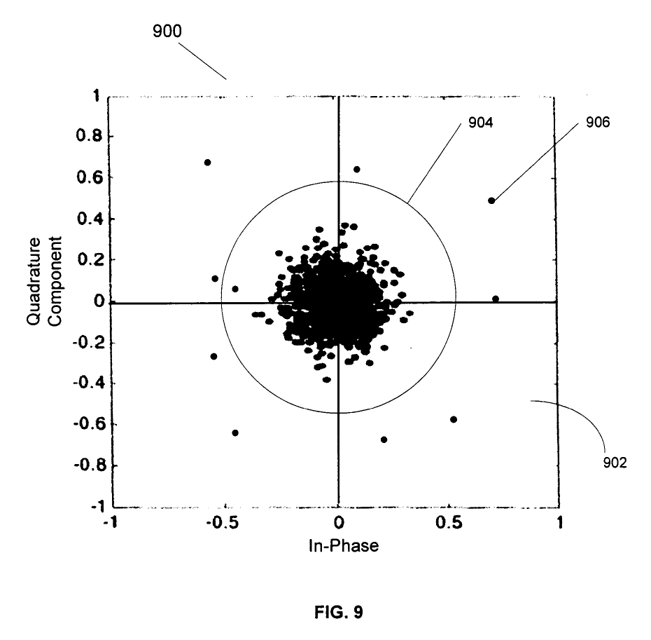

The outlier counter 804 analyzes each noise power value for each tone of the N-byte array 710 and compares that value to an outlier threshold value. An outlier count is incremented by one for each noise power value that exceeds the outlier threshold value. For example, FIG. 9 illustrates a constellation point 900 composed of a plurality of error samples that correspond to calculated noise power values. The outlier threshold 904 illustrates error samples within a defined perimeter corresponding to normal Gaussian noise. Error sample 906 illustrates an error sample outside of the outlier threshold 904 that may correspond to an impulse noise contribution. As illustrated, the outlier threshold 904 is set high enough so that not many samples of Gaussian noise pass that level. But, it also is low enough that the magnitude of the instantaneous error on several tones will pass that threshold when the frame is severely corrupted by non-Gaussian noise sources, such as impulse noise.

The total number of outlier values is then passed to severely corrupted frame module 806 to determine if the total outlier count is greater than an outlier frequency threshold value. If the outlier frequency threshold value is exceeded, the data frame is corrupt and the severely corrupted frame module 708 generates an N-bit array 712 of flag values, each set to a value indicating the frame composed of N-byte array 710 is corrupt (e.g., set to ‘1’). However, if the data frame is not corrupt, then the corrupted frame module 708 generates an N-bit array 712 of flag values, wherein each flag value is set to indicate the frame composed of N-byte array 710 is not corrupt (e.g., set to ‘0’). In either case, a plurality of N-bit and N-byte arrays corresponding to corrupt and non-corrupt frames are de-interleaved, decoded, and corrected, as discussed above with respect to erasure decoding.

In one embodiment, the outlier threshold value is set to be an outlier threshold factor times the average total noise power, as discussed above. In another embodiment, the outlier frequency threshold may be set to an outlier frequency threshold factor times the number of loaded tones. The outlier threshold factor and outlier frequency threshold factor are design parameters that determine the sensitivity of the corrupted frame detector. As these parameters increase the detector becomes less sensitive and may fail to detect some severely corrupted frames. On the other hand, as these parameters decrease the detector becomes more sensitive and may generate false alarms.

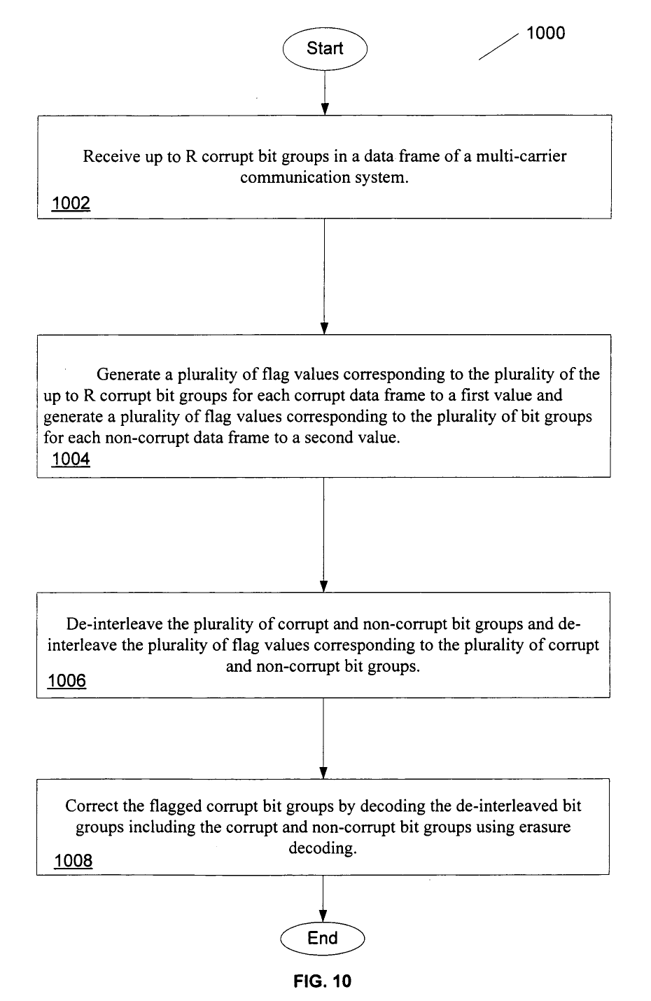

FIG. 10 is a flow chart illustrating an embodiment of a method for receiving, detecting and correcting corrupt bit groups in a multi-carrier communication system (hereinafter ‘the system’). At operation 1002, the system receives up to R number of corrupted bit groups in a data frame and if corrupt, corrects the up to R number of corrupted bit groups.

At operation 1004, the system generates a plurality of flag values corresponding to the plurality of the up to R bit groups for each corrupt data frame of the plurality of data frames to a first value and generating a plurality of flag values corresponding to the plurality of bit groups for each non-corrupt data frame of the plurality of data frames to a second value.

At operation 1008, the system de-interleaves a plurality of corrupt and non-corrupt bit groups and de-interleaves a plurality of flag values corresponding to the plurality of corrupt and non-corrupt bit groups.

The system further operates to correct the corrupt bit groups by decoding the de-interleaved bit groups including the corrupt and non-corrupt bit groups using erasure decoding, at operation 1010.

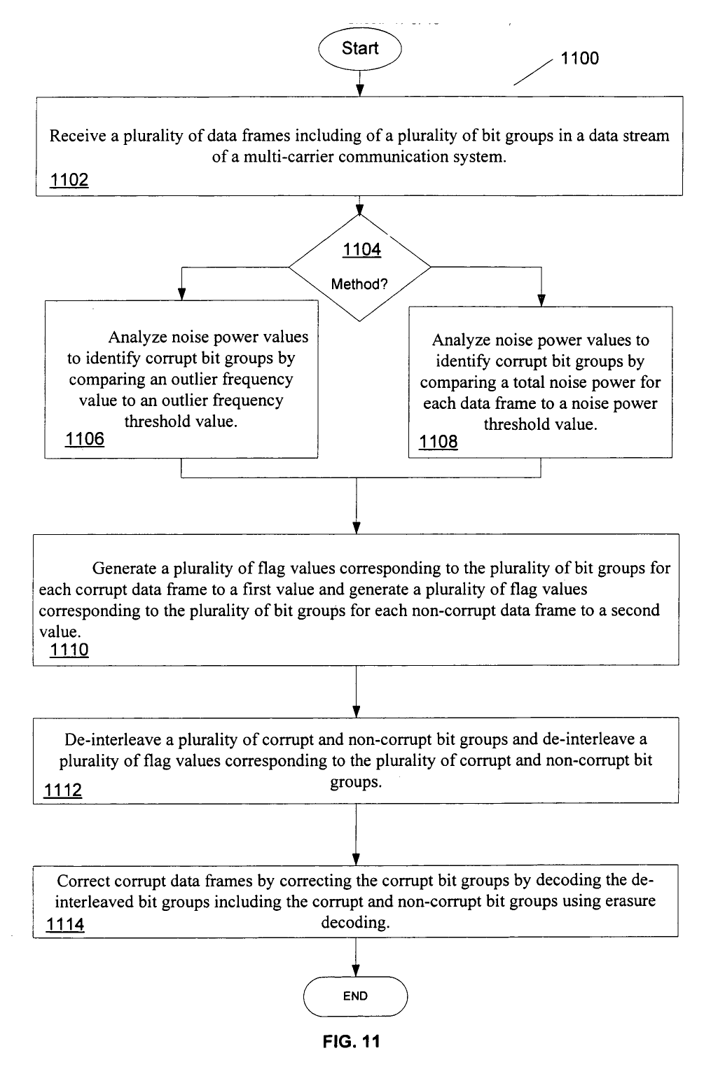

FIG. 11 is a flow chart illustrating other embodiments of the present invention for detecting and correcting corrupt bit groups using noise power values of received tones to identify corrupt frames in a multi-carrier communication system. At operation 1102 the system receives a plurality of data frames comprised of a plurality of bit groups in a data stream of a multi-carrier communication system, wherein the up to R bit groups are identified as corrupted by analyzing corresponding tone values, and correcting the R bit groups.

The operation of analyzing may be accomplished by two different operations, as selected at operation 1104. At operation 1106, the analysis includes analyzing noise power values by comparing an outlier frequency value to an outlier frequency threshold value.

At operation 1108, the alternate analysis includes analyzing noise power values by comparing total noise power for each data frame to a noise power threshold value.

Operation 1110 includes generating a plurality of flag values corresponding to the plurality of bit groups for each corrupt data frame of the plurality of data frames to a first value and generating a plurality of flag values corresponding to the plurality of bit groups for each non-corrupt data frame of the plurality of data frames to a second value.

Once generated, operation 1112, the system de-interleaves the plurality of corrupt and non-corrupt bit groups and de-interleaves the plurality of flag values corresponding to the plurality of corrupt and non-corrupt bit groups. Lastly, at operation 1114, the process concludes by correcting the corrupt bit groups by decoding the de-interleaved bit groups including the corrupt and non-corrupt bit groups using erasure decoding.

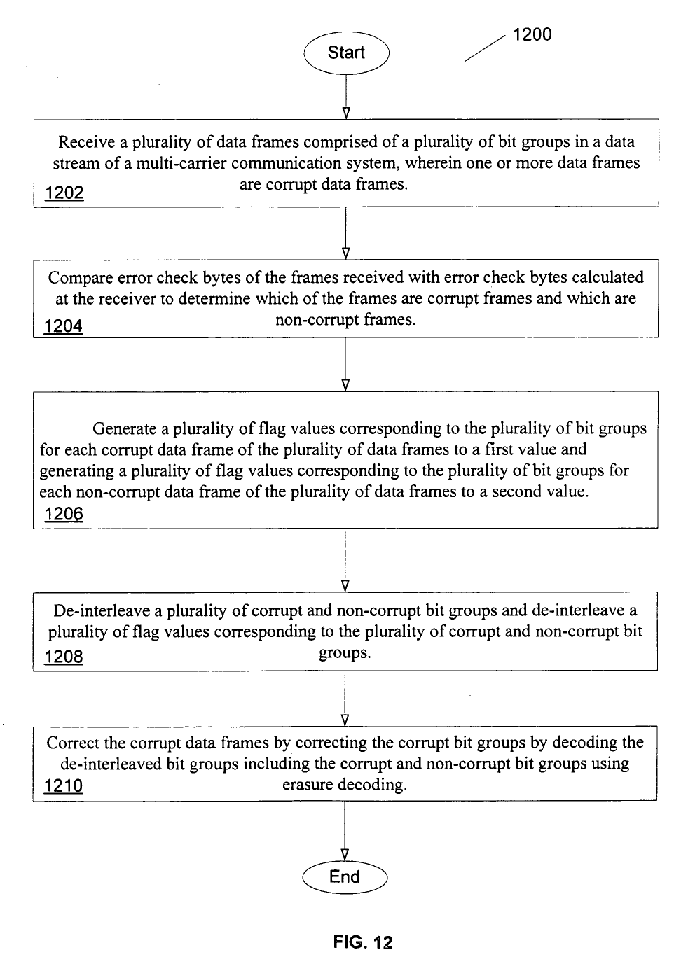

FIG. 12 is a flow chart illustrating an embodiment for detecting and correcting corrupt bit groups in a data frame using error check bytes to identify corrupt frames in a multi-carrier communication system. At operation 1202 the system receives a plurality of data frames comprised of a plurality of bit groups in a data stream of a multi-carrier communication system, wherein up to R bit groups are identified as corrupted by analyzing corresponding tone values, and correcting the corrupted bit groups.

Operation 1206 includes generating a plurality of flag values corresponding to the plurality of bit groups for each corrupt data frame of the plurality of data frames to a first value and generating a plurality of flag values corresponding to the plurality of bit groups for each non-corrupt data frame of the plurality of data frames to a second value.

Once generated, at operation 1208 includes de-interleaving a plurality of corrupt and non-corrupt bit groups and de-interleaving a plurality of flag values corresponding to the plurality of corrupt and non-corrupt bit groups. Lastly, at operation 1210, the process concludes by correcting the corrupt bit groups as identified by the error check byte comparison of operation 1204 by decoding the de-interleaved bit groups including the corrupt and non-corrupt bit groups using erasure decoding.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

For example, a machine-readable medium may be provided having one or more instructions stored thereon, which instructions may be used to program a computer system or other electronic device to perform the operations described. A machine-readable medium may include any mechanism for storing or transmitting information in a form (e.g., software or processing application) readable by a machine (e.g., a computer). The machine-readable medium may include, but is not limited to, magnetic storage media (e.g., a floppy diskette), optical storage media (e.g., CD-ROM, CD-RW, DVD, etc.), magneto-optical storage media, read only memory (ROM), random access memory (RAM), erasable programmable memory (e.g., EPROM and EEPROM), flash memory, electrical, optical, acoustical, or other forms of propagated signal (e.g. carrier waves, infrared signals, digital signals, etc.), or other types of media suitable for storing electronic instructions.

The instructions and operations also may be practiced in distributed computing environments where the machine-readable media is stored on and/or executed by more than one computer system. In addition, the information transferred between computer systems may either be pulled or pushed across the communication media connecting the computer systems.

In general, although exemplary frequencies and tones are used in the description above, other frequencies, tones, and combinations thereof may be applicable to or affected by certain embodiments of the present invention.

Furthermore, referring to FIG. 4, although the communication system 400 is described above in the context of an ADSL system, the communication system 400 is representative of alternative types of communication systems, such as wireless radio frequency (RF), that may employ multi-carrier communication schemes to communicate data from a transmitter to a receiver.

In an embodiment, the transmitter-receiver device may take advantage of an extremely low noise, high linearity ADSL Analog Front End (AFE) and digital echo canceller, providing excellent long loop and bridge tap performance.

Thus, the transmitter-receiver device may reduce the need for a technician visit and provides superior modem training capability, particularly for those customers at the edge of the DSL coverage area.

The transmitter-receiver device may utilize impulse noise compensation and non-linear echo compensation to increase reliability and performance in actual ADSL end user environments. The transmitter-receiver device may detect real-world conflicts such as dimmer switches, fluorescent lighting, AM radio interference, unfiltered devices connected to the ADSL line (alarm systems, water meters, and half ringers) and poor wiring. This extra step ensures a better user experience, reduces truck rolls, and reduces lengthy troubleshooting calls.

Referring to FIGS. 10-12, although the embodiments of the impulse noise detection method as shown in the form of flow charts having separate blocks and arrows, the operations described in a single block do not necessarily constitute a process or function that is dependent on or independent of the other operations described in other blocks. Furthermore, the order in which the operations are described herein is merely illustrative, and not limiting, as to the order in which such operations may occur in alternate embodiments. For example, some of the operations described may occur in series, in parallel, or in an alternating and/or iterative manner. Another approach is also possible.

While some specific embodiments of the invention have been shown the invention is not to be limited to these embodiments. The invention is to be understood as not limited by the specific embodiments described herein, but only by scope of the appended claims.

We claim:

1. A method, comprising:
receiving a plurality of data frames comprised of a plurality of bit groups in a data stream of a multi-carrier communication system, wherein up to R bit groups are identified as corrupted by analyzing corresponding tone values; and
correcting the up to R bit groups associated with one or more corrupt frames of the plurality of data frames.

2. The method of claim 1, further comprising identifying one or more corrupt frames of the plurality of data frames by analyzing a plurality of noise power values corresponding to tone values associated with each data frame.

3. The method of claim 2, wherein analyzing comprises:
adding together the plurality of noise power values to generate a total noise power for each data frame; and
comparing the total noise power to a threshold value, wherein a data frame is corrupt if the total noise power exceeds the threshold value.

4. The method of claim 3, further comprising calculating the threshold value based on at least one of an average total noise power and a variance of the total noise power, each based upon noise power values from previously received tones.

5. The method of claim 2, wherein analyzing comprises:
comparing each of the plurality of noise power values to an outlier threshold value to generate an outlier count; and
comparing an outlier frequency threshold value to an outlier frequency based on the outlier count divided by the number of tones in each data frame, wherein each data frame is corrupt if the outlier frequency exceeds the outlier frequency threshold value.

6. The method of claim 5, further comprising calculating the outlier threshold value and the outlier frequency value based on at least one of an average total noise power and a variance of the total noise power, each based upon noise power values from previously received tones.

7. The method of claim 2, wherein if a first data frame is a corrupt frame, generating a first plurality of flag values corresponding to a first plurality of bit groups comprising the corrupt frame with a first value.

8. The method of claim 7, wherein if a second data frame is a non-corrupt frame, generating a second plurality of flag values corresponding to a second plurality of bit groups comprising the non-corrupt frame with a second value.

9. The method of claim 8, further comprising:
de-interleaving the first and the second plurality of bit groups comprising the corrupt frame and the non-corrupt frame to generate a de-interleaved bit group array; and
de-interleaving the first and the second plurality of flag values corresponding to the first and the second plurality of bit groups associated with the corrupt frame and non-corrupt frame to generate a de-interleaved flag bit array.

10. The method of claim 9, further comprising:
correcting the first plurality of bit groups corresponding to one or more corrupt data frames by decoding the de-interleaved bit group array using the de-interleaved flag bit array and erasure decoding.

11. The method of claim 10, wherein the erasure decoding algorithm is a Reed-Solomon erasure decoding algorithm.

12. The method of claim 1, wherein the bit group is a byte of data.

13. The method of claim 1, wherein the bit group comprises one or more bytes.

14. A machine readable medium having embodied thereon an instruction set, the instruction set being executable by a machine to perform operations comprising:
receiving a plurality of data frames comprised of a plurality of bit groups in a data stream of a multi-carrier communication system, wherein up to R bit groups are identified as corrupted by analyzing corresponding tone values; and
correcting the up to R bit groups associated with one or more corrupt frames of the plurality of data frames.

15. The machine readable medium of claim 14, further comprising identifying one or more corrupt frames of the plurality of data frames by analyzing a plurality of noise power values corresponding to tone values associated with each data frame.

16. The machine readable medium of claim 15, wherein if a first data frame is a corrupt frame, generating a first plurality of flag values corresponding to a first plurality of bit groups comprising the corrupt frame with a first value.

17. The machine readable medium of claim 16, wherein if a second frame is a non-corrupt frame, generating a second plurality of flag values corresponding to a second plurality of bit groups comprising the non-corrupt frame with a second value.

18. The machine readable medium of claim 17, further comprising:
de-interleaving the first and the second plurality of bit groups comprising the corrupt frame and the non-corrupt frame to generate a de-interleaved bit group array; and
de-interleaving the first and the second plurality of flag values corresponding to the first and the second plurality of bit groups associated with the corrupt frame and non-corrupt frame to generate a de-interleaved flag bit array.

19. The machine readable medium of claim 18, wherein further comprising:
correcting the first plurality of bit groups corresponding to one or more corrupt data frames by decoding the de-interleaved bit group array using the de-interleaved flag bit array and erasure decoding.

20. An apparatus, comprising:
a receiver to receive a plurality of data frames comprised of a plurality of bit groups in a data stream of a multi-carrier communication system;
a corrupted frame detector to analyze a plurality of noise power values corresponding to tone values associated with each data frame of the plurality of data frames to identify up to R corrupt bit groups of the plurality of bit groups; and
a decoder to decode the plurality of bit groups and to correct the up to R corrupt bit groups associated with one or more corrupt frames of the plurality of data frames.

21. The apparatus of claim 20, wherein to analyze, the corrupted frame detector to add together the plurality of noise power values to generate a total noise power for each data frame, and to compare the total noise power to a threshold value, wherein a data frame is corrupt if the total noise power exceeds the threshold value.

22. The apparatus of claim 21, the corrupted frame detector further to calculate the threshold value based on at least one of an average total noise power and a variance of the total noise power, each based upon noise power values from previously received tones.

23. The apparatus of claim 20, wherein to analyze, the corrupted frame detector to compare each of the plurality of noise power values to an outlier threshold value to generate an outlier count, and to compare an outlier frequency threshold value to an outlier frequency based on the outlier count divided by the number of tones in each data frame, wherein each data frame is corrupt if the outlier frequency exceeds the outlier frequency threshold value.

24. The apparatus of claim 23, the corrupted frame detector further to calculate the outlier threshold value based on average noise power per tone from previously received tones multiplied by an outlier sensitivity factor.

25. The apparatus of claim 20, wherein if a first data frame is a corrupt frame, the corrupted frame detector further to generate a first plurality of flag values corresponding to a first plurality of bit groups comprising the corrupt frame with a first value.

26. The apparatus of claim 20, wherein if a second data frame is a non-corrupt corrupt frame, the corrupted frame detector further to generate a second plurality of flag values corresponding to a second plurality of bit groups comprising the non-corrupt frame with a second value.

27. The apparatus of claim 26, further comprising:
a de-interleaver to de-interleave the first and the second plurality of bit groups comprising the corrupt frame and the non-corrupt frame to generate a de-interleaved bit group array, and to de-interleave the first and the second plurality of flag values corresponding to the first and the second plurality of bit groups associated with the corrupt frame and non-corrupt frame to generate a de-interleaved flag bit array.

28. The apparatus of claim 27, wherein the decoder further to correct the first plurality of bit groups corresponding to one or more corrupt data frames by decoding the de-interleaved bit group array using the de-interleaved flag bit array and erasure decoding.

29. The apparatus of claim 28, wherein the erasure decoding algorithm is a Reed-Solomon erasure decoding algorithm.

30. The apparatus of claim 27, wherein the de-interleaver is a dual field de-interleaver comprised of a flag bit de-interleaver and a bit group de-interleaver, wherein at least one of the flag bit de-interleaver and the bit group de-interleaver is implemented in software and the other implemented in hardware.
